(19) United States
(12) Patent Application Publication
(10) Pub. No.: US 2021/0193368 A1
(43) Pub. Date: Jun. 24, 2021

(54) POWER TRANSFORMER AND METHOD FOR MANUFACTURING THE SAME

(71) Applicant: Silergy Semiconductor Technology (Hangzhou) LTD, Hangzhou (CN)

(72) Inventors: Ke Dai, Hangzhou (CN); Jian Wei, Hangzhou (CN); Jiajia Yan, Hangzhou (CN)

(21) Appl. No.: 17/118,870

(22) Filed: Dec. 11, 2020

(30) Foreign Application Priority Data
Dec. 20, 2019 (CN) 201911327473.1

(51) Int. Cl. H01F 27/28; H01F 27/24; H01F 41/02; H01F 41/04

(52) U.S. Cl. CPC H01F 27/2804; H01F 27/24; H01F 2027/2809; H01F 41/041; H01F 41/0206

(57) ABSTRACT

A power transformer can include: a magnet layer that is the only magnet layer in the power transformer; at least one primary winding layer having a plane that is parallel to the magnet layer; at least one secondary winding layer having a plane that is parallel to the magnet layer; and where along a vertical direction of the transformer, both the primary and secondary winding layers are located on a same side of the magnet layer.

### RELATED APPLICATIONS

This application claims the benefit of Chinese Patent Application No. 201911327473.1, filed on Dec. 20, 2019, which is incorporated herein by reference in its entirety.

### FIELD OF THE INVENTION

The present invention generally relates to the field of power electronics, and more particularly to power transformers and methods of manufacturing power transformers.

### BACKGROUND

An increase in switching frequency can allow for a reduction in the volume of magnetic components. Thus, current IC packages for integrated power supplies are developing toward high frequency in order to increase the overall power density of the power supply. The thickness of the magnetic element is an important indicator of the magnetic element. For the same loss and material, the thinner the magnetic element, the lower the thermal resistance of the magnetic element, the lower the temperature, and the higher the reliability of the entire device. However, the thickness of a traditional transformer may not be effectively improved by increasing the switching frequency.

### BRIEF DESCRIPTION OF THE DRAWINGS

FIG. 1 is structural diagram of an example power transformer, in accordance with embodiments of the present invention.

FIG. 2 is a flow diagram of an example IC packaging process of the power transformer, in accordance with embodiments of the present invention.

FIG. 3 is a schematic diagram of two type winding arrangements of the power transformer, in accordance with embodiments of the present invention.

FIG. 4 is a schematic diagram of an example magnetic circuit of the power transformer, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Commonly used transformers are mainly divided into two types: a wound transformer, which is a transformer formed by winding copper wires on a magnetic core; and a PCB winding transformer, where the copper wire is replaced by a printed circuit board. For wound transformers, the thickness of the transformer is the sum of the thickness of an upper core cover plate and a lower core cover plate, the thickness of a wound window, and the thickness of the thickness of a wound base. The minimum thickness of the transformer is limited by the physical properties of the material itself, processing technology, and the manufacturing process, regardless of the switching frequency. For example, if the diameter of the wound single-strand enameled wire is less than 0.09 mm, the wire can easily break. When a specific turns ratio is required for n:1, the transformer may need to be at least n+1 turns. Therefore, the height of the window may need to be 0.11 mm*2=0.22 mm (e.g., with patent leather), even in the most extreme case of 1:1. If the filling ratio of window height is 0.9, the window height may need to be 0.25 mm, even in the case of 1 turn of primary side and 1 turn of secondary side. The thickness of the ferrite core may be required to be greater than 0.5 mm in the process, and otherwise may be easily broken. As such, the thickness of the wound transformer should be greater than 1.25 mm. In actual products, it is rare that the primary and secondary sides have only 1 turn. Therefore, the thinnest commercial transformer is generally greater than 1.5 mm.

For traditional printed-circuit board (PCB) transformers, the thickness of the transformer is the sum of the thickness of an upper core cover plate, a lower core cover plate, and the PCB board. The thickness of the ferrite core cover plate of the transformer typically needs to be greater than 0.5 mm. The thinnest PCB board may also need to be greater than 0.25 mm. Therefore, the thickness of the traditional PCB transformer structure is also difficult to achieve below 1 mm. Furthermore, if the transformer has high isolation or high withstand voltage requirements, the transformer will be even thicker. Of course, air-core transformers used in the digital signal isolators integrated in some IC packages can be relatively thin. However, the coupling coefficient of this type of air-core transformer is quite low (e.g., around 70%), and may not be suitable for power transmission.

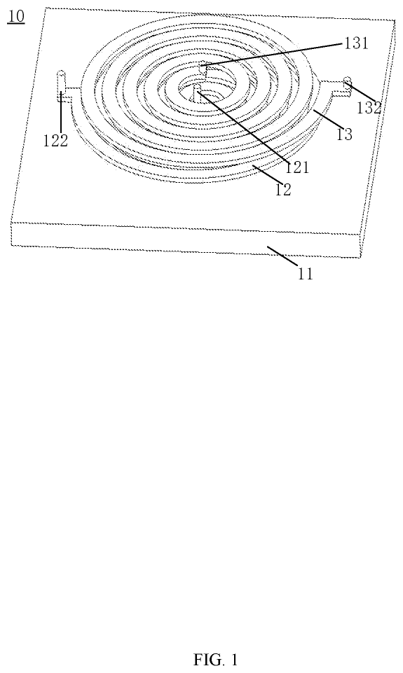

Referring now to FIG. 1, shown is structural diagram of an example power transformer, in accordance with embodiments of the present invention. In this particular example, power transformer 10 can include only one magnet layer 11, at least one primary winding layer 13, and at least one secondary winding layer 12. A plane of primary winding layer 13 and a plane of secondary winding layer 12 may both be parallel to magnet layer 11. Primary winding layer 13 and secondary winding layer 12 can be located on the same side of magnet layer 11. In this example, primary winding layer 13 and secondary winding layer 12 are arranged on the upper side of magnet layer 11. In certain embodiments, secondary winding layer 12 can be adjacent to magnet layer 11 (e.g., in the vertical direction of the transformer), magnet layer 11 may be located on a first side of secondary winding layer 12, and primary winding layer 13 can be located on a second side of secondary winding layer 12, where the first side of secondary winding layer 12 is opposite to the second side of secondary winding layer 12. In other embodiments, primary winding layer 13 may also be selected to be adjacent to magnet layer 11.

For example, magnet layer 11 can be configured as a sheet-shaped thin-film magnet to reduce the thickness of power transformer 10. The material of magnet layer 11 can be selected from one of: manganese-zinc ferrite, nickel-zinc ferrite, iron powder, metal powder core, amorphous ribbon, nanocrystalline ribbon, and the like. Further, the sheet-shaped thin-film magnet may be a cast ferrite film, such as manganese-zinc ferrite or nickel-zinc ferrite, in order to increase magnetic permeability and saturation magnetic induction, and to reduce magnetic loss. Further, the coverage area of magnet layer 11 may not be less than the area of the main body part of coils of primary winding layer 13, and not less than the area of the main body part of coils of secondary winding layer 12. Thereby, a path with smaller magnetic resistance may be provided for the main flux to improve the coupling coefficient. In addition, the shape of magnet layer 11 can be square or round, as long as it can cover the area of the main body part of the coils. For example, the main body part of the coils may not include an outlet wire part.

Primary winding layer 13 and secondary winding layer 12 can be formed by using an integrated circuit (IC) packaging process. In FIG. 1, magnetic layer 11 is a sheet-shaped thin-film magnetic core, which may be a ferrite thin film formed by a casting process. For example, the thickness of ferrite thin film is about 0.08 mm to 0.6 mm in the current process. When the coils of primary winding layer 13 and the coils of secondary winding layer 12 are formed in combination with the IC packaging process, for a 3000V withstand voltage example, and when copper wire is selected, the thickness of power transformer can theoretically be 0.27 mm (e.g., 10 um copper [two layers], 0.15 mm ferrite thin film [one layer], 0.1 mm dielectric layer). Of course, in some cases, the thickness of 50 um copper, 0.2 mm ferrite may be used. In this case, the thickness of the transformer can also be controlled to be near 0.5 mm. This is at least two-thirds less than the thickness of traditional commercial transformers. It can be understood that the coils of primary winding layer 13 and the coils of secondary winding layer 12 can also be wound with other materials, such as silver.

Primary winding layer 13 and secondary winding layer 12 can also be formed using PCB board technology. The coils in primary winding layer 13 and secondary winding layer 12 may be formed on PCB boards, whereby the first winding layer and the second winding layer are respectively formed on two opposite sides of the PCB board. Two opposite sides of the PCB board may have grooves for accommodating the first and second winding layers. When redistribution layer (RDL) copper wire is selected, the thickness can be 0.4 mm (e.g., 0.25 mm PCB board, 0.15 mm thin film ferrite), or even thinner.

It should be noted that the power transformer of particular embodiments is not limited to a structure with only one primary winding layer 13 and one secondary winding layer 12, and instead more than one primary winding layer 13 and more than one secondary winding layer 12 can be included in order to meet the design requirements in different applications. When there are multiple primary winding layers 13 and multiple secondary winding layers 12, due to the characteristics of the PCB board process, multilayer wiring can be better performed. For example, the output terminals of the coils in primary winding layer 13 and secondary winding layer 12 may both be arranged on a side which is not adjacent to magnet layer 11. As compared with the traditional transformer with magnetic cores on both sides of the winding layers, power transformer 10 of particular embodiments may have only one magnetic layer 11. Thus, the side where primary winding layer 13 and secondary winding layer 12 are not adjacent to magnet layer 11 can lead out the output terminals conveniently without the hindrance of the magnet layer.

In particular embodiments (e.g., according to the circuit simulation results), when secondary winding layer 12 is arranged adjacent to magnet layer 11 and primary winding layer 13 is adjacent to secondary winding layer 12, the winding arrangement in the example of FIG. 1 can result in a higher coupling coefficient. The applicable circuit topology of the power transformer of particular embodiments be applied to the field of power electronics, and all topologies of traditional transformers. In addition, the two winding layers of the power transformer of particular embodiments can also be the two windings of a coupled inductor, and as such can be used as a coupled inductor.

In particular embodiments, the power transformer may adopt a magnetic core structure with one magnetic layer, at least one primary winding layer, and at least one secondary winding layer on the same side of the magnetic layer are arranged as planar windings. Also, the plane of primary winding layer and the plane of secondary winding layer may both be parallel to the magnet layer. Therefore, a thinner size than existing transformers with a magnetic core can be achieved, and a higher coupling coefficient than existing transformers without a magnetic core can be achieved.

In particular embodiments, a method for manufacturing a power transformer, can include: forming laminated a first winding layer and a second winding layer; and providing one magnet layer. For example, the plane of the first winding layer is parallel to the magnet layer, the plane of the second winding layer is parallel to the magnet layer, and along the vertical direction of the transformer, and both the first winding layer and the second winding layer are located on the same side of the magnet layer. When the power transformer is formed using PCB board technology, the first and second winding layers are formed on a PCB board, and the magnet layer is located below the PCB board. For example, the first and second winding layers may respectively be formed on two opposite sides of the PCB board. Further, to opposite sides of the PCB board may have grooves for accommodating the first and second winding layers.

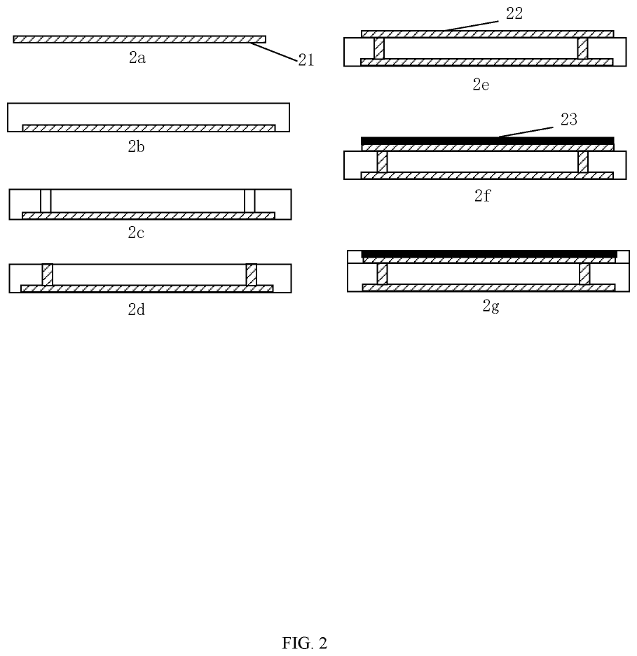

Referring now to FIG. 2, shown is a flow diagram of an example IC packaging process of the power transformer, in accordance with embodiments of the present invention. This particular example manufacturing method can include, plating a metal on a substrate to form winding layer 21, and encapsulating winding layer 21 to form a first encapsulation body. The method can also include forming holes in the first encapsulation body, and filling the holes with the metal. The method can also include plating the metal on the first encapsulation body to form winding layer 22. The method can also include adding magnet layer 23 on winding layer 22, and encapsulating magnet layer 23 to form a second encapsulation body. For example, the substrate may be removed after encapsulating magnet layer 23. For example, the metal can be copper or silver.

For example, as shown in 2a of FIG. 2, copper can be plated on the substrate to form winding layer 21. In 2b of FIG. 2, winding layer 21 may be encapsulated to form a first encapsulated body. In 2c of FIG. 2, holes can be punched in the first encapsulation body. In 2d of FIG. 2, the holes may be filled with copper. In 2e of FIG. 2, copper may be plated on the first encapsulation body to form winding layer 22. In 2f of FIG. 2, magnet layer 23 can be added to winding layer 22. In 2g of FIG. 2, magnet layer 23 may be encapsulated. For example, winding layer 21 can be configured as a primary winding layer, and winding layer 22 can be configured as a secondary winding layer.

Also, output terminals of winding layers 21 and 22 may both be located on the side that is not adjacent to magnet layer 23. Since there is no obstruction under winding layer 21, the output terminals can be directly led out therefrom, but the output terminals of winding layer 22 may pass through the copper-plated hole to lead out. In particular embodiments, the area of the magnet layer 23 may not be less than the area of the main body part of the coils of winding layer 21, and not less than the area of the main body part of the coils of winding layer 22. In this way, a higher coupling coefficient can be achieved. Where the main body part of the coils do not include outlet wire part.

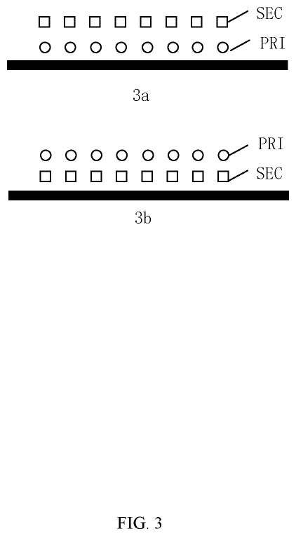

Referring now to FIG. 3, shown is a schematic diagram of two type winding arrangements of the power transformer, in accordance with embodiments of the present invention. As a power transformer, the structure of particular embodiments can ensure that there is a high coupling coefficient between the primary winding and secondary winding. The positions of the primary and secondary windings can have the two setting methods, as shown in 3a and 3b of FIG. 3. In example 3a of FIG. 3, when the primary winding PRI is adjacent to the magnet layer and secondary winding SEC is far away from the magnet layer, the coupling coefficient, e.g., K=0.905 can be obtained. In example 3b of FIG. 3, when the primary winding PRI is far away from the magnet layer, and the secondary winding SEC is adjacent to the magnet layer, the coupling coefficient, e.g., K=0.983 can be obtained. It can be seen that the two winding arrangement ways can achieve a higher coupling coefficient of 0.9 or more. Further, the arrangement way that secondary winding SEC is adjacent to the magnet layer can achieve a higher coupling coefficient between the primary and secondary windings.

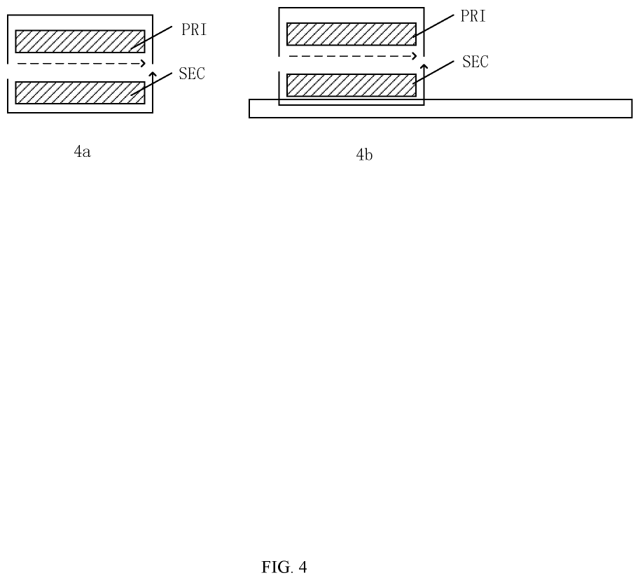

Referring now to FIG. 4, shown is a schematic diagram of an example magnetic circuit of the power transformer, in accordance with embodiments of the present invention. Example 4a of FIG. 4 is a schematic diagram of the magnetic circuit of an air-core transformer without a magnetic core. Example 4b of FIG. 4 is a schematic diagram of the magnetic circuit of the power transformer of particular embodiments. Among them, the leakage magnetic flux loop is represented by a dotted line, and the main magnetic flux loop is represented by a solid line. As compared with an air-core transformer without a magnetic core, in the power transformer of particular embodiments, the magnetic resistance of the path of the main magnetic flux loop that is mainly used for transmission can be substantially reduced due to the existence of the magnet layer. Therefore, the proportion of the main magnetic flux coupled to the secondary winding can increase, and the coupling coefficient may accordingly be higher.

In particular embodiments, a power transformer may adopt a magnetic core structure with a single magnetic layer, at least one primary winding layer, and at least one secondary winding layer on the same side of the magnetic layer and arranged as planar windings, whereby the planes are all parallel to the magnet layer. In this way, a thinner size than existing transformers with a magnetic core, and a higher coupling coefficient than the existing transformer without a magnetic core, can be achieved.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A power transformer, comprising:
a) a magnet layer that is the only magnet layer in the power transformer;
b) at least one primary winding layer having a plane that is parallel to the magnet layer;
c) at least one secondary winding layer having a plane that is parallel to the magnet layer; and
d) wherein along a vertical direction of the transformer, both the primary and secondary winding layers are located on a same side of the magnet layer.

2. The power transformer of claim 1, wherein the magnet layer is configured as a sheet-shaped thin-film magnet.

3. The power transformer of claim 2, wherein the sheet-shaped thin-film magnet is configured as a cast ferrite thin film.

4. The power transformer of claim 1, wherein the primary winding layer and the secondary winding layer are formed by an integrated circuit packaging process.

5. The power transformer of claim 1, wherein the primary winding layer and the secondary winding layer are formed by PCB board technology.

6. The power transformer of claim 1, wherein the secondary winding layer is adjacent to the magnet layer, and the primary winding layer is adjacent to the secondary winding layer.

7. The power transformer of claim 6, wherein along the vertical direction of the transformer, the magnet layer is located on a first side of the secondary winding layer, and the primary winding layer is located on a second side of the secondary winding layer, and wherein the first side is opposite to the second side.

8. The power transformer of claim 1, wherein output terminals of the primary winding layer and output terminals of the secondary winding layer are both arranged on a side which is not adjacent to the magnet layer.

9. The power transformer of claim 1, wherein an area of the magnet layer is not less than the area of main body part of coils of the primary winding layer, and is not less than the area of main body part of coils of the secondary winding layer.

10. The power transformer of claim 1, wherein the magnet layer comprises one of: manganese-zinc ferrite, nickel-zinc ferrite, iron powder, metal powder core, amorphous ribbon, and nanocrystalline ribbon.

11. A method of manufacturing a power transformer, the method comprising:
a) forming first and second winding layers;
b) providing a magnet layer that is the only magnet layer in the power transformer;
c) wherein a plane of the first winding layer is parallel to the magnet layer, and the plane of the second winding layer is parallel to the magnet layer; and
d) along the vertical direction of the transformer, both the first and second winding layers are located on a same side of the magnet layer.

12. The method of claim 11, wherein the first and second winding layers are formed on a PCB board, and the magnet layer is located below the PCB board.

13. The method of claim 12, wherein the first and second winding layers are respectively formed on two opposite sides of the PCB board.

14. The method of claim 11, wherein the forming the first and second winding layers comprises:
a) plating a metal on a substrate to form the first winding layer;
b) encapsulating the first winding layer to form a first encapsulation body;
c) forming holes in the first encapsulation body;
d) filling the holes with the metal; and
e) plating the metal on the first encapsulation body to form the second winding layer.

15. The method of claim 14, further comprising, after the forming the second winding layer:
a) adding the magnet layer on the second winding layer; and
b) encapsulating the magnet layer.

16. The method of claim 14, wherein the metal comprises copper or silver.

17. The method of claim 11, wherein the magnet layer is configured as a sheet-shaped thin-film magnet.

18. The method of claim 14, wherein output terminals of the first winding layer and output terminals of the second winding layer are both arranged on a side that is not adjacent to the magnet layer, and the output terminals of the second winding layer are led out through the holes.

19. The method of claim 11, wherein the area of the magnet layer is not less than the area of main body part of coils of the first winding layer, and not less than the area of main body part of coils of the second winding layer.

20. The method of claim 11, wherein the magnet layer comprises one of: manganese-zinc ferrite, nickel-zinc ferrite, iron powder, metal powder core, amorphous ribbon, and nanocrystalline ribbon.
